(19) United States
(12) Patent Application Publication
(10) Pub. No.: US 2015/0300083 A1
(43) Pub. Date: Oct. 22, 2015

(54) SAFETY DEVICE FOR A WINDOW BLIND

(71) Applicant: Jared Justin Manske, Breckenridge, CO (US)

(72) Inventor: Jared Justin Manske, Breckenridge, CO (US)

(21) Appl. No.: 14/257,224

(22) Filed: Apr. 21, 2014

(51) Int. Cl. E06B 9/38

(52) U.S. Cl. CPC E06B 9/38

(57) ABSTRACT

A safety device for a window blind, comprising of: a telescoping pole having plurality of tubular sections and a handle; wherein a first tubular section of the telescoping pole is attached to a window blind and a third tubular section of the telescoping pole is attached to the handle and at least one cord from the window blind is fed through the plurality of tubular sections all the way to said handle wherein the cord is tied into a knot so that the cord doesn't go back through the handle whereby the safety device protects kids from wrapping themselves up in the cord.

### FIELD OF THE INVENTION

The present invention relates to window blind. More particularly, the present invention relates to a safety device for window blinds which are operated by cords.

### BACKGROUND OF THE INVENTION

Blinds are commonly used in windows and other apertures so that privacy may be maintained and light transfer between the internal and external surroundings can be controlled. The ability to reduce amount of sun light entering a room also helps in reducing heat load. Blinds are also used for separating spaces since they are easily maneuverable and aesthetically appealing. A window blind usually includes a plurality of slats, vanes or fabric pleats hung from a head rail. Blinds can be typically closed and opened by using cords.

There are different types of conventional window blinds, including the roman blind and the venetian blinds. The roman blind has a curtain cloth mounted to an inner side of a window, and one side of the curtain cloth is provided with some guide rings. Some cords extend through the guide rings, and are then connected to a bottom portion of the curtain cloth. Manipulation of the cords results in folding and unfolding of the curtain cloth.

Venetian blinds have a headrail, a bottom rail and a set of slats carried on ladders that extend from the headrail to the bottom rail. Lift cords extend from the bottom rail through or adjacent the slats and into the headrail. The lift cords may be wound and unwound on an axle within the headrail, but more commonly pass through a cord lock in the headrail and exit the headrail at one end. Conventional cord locks will restrain the lift cords when the blind is in a fully raised, or partially lowered, position. But, typically those cord locks do not lock the cords in place when the blind is fully lowered. Consequently, anyone can grasp a lift cord of a fully lowered blind and pull the lift cord away from the blind. Children sometimes wrap the hanging cord around themselves while playing which creates a potential threat of strangulation. Indeed, some children have become entangled in a cord loop created in this way and have been strangled. Consequently, the industry has been encouraged to provide safety devices on blinds to prevent cords from being pulled away from the slats.

There is a need for a mechanism that can be used in blinds that will prevent loose cords from being pulled away from a fully lowered blind. That mechanism should not detract from either the operation or appearance of the blind.

### OBJECTS OF THE INVENTION

An object of the invention is to provide a safety device for a window blind.

Another object of the invention is to provide a safety device which provides protection to children from getting strangled in a chord of the window blind.

Yet another object of the invention is to provide a safety device that is easy to use.

### BRIEF SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is applicable to both window blinds and shades. For convenience, blinds and shades will simply be referred to herein as blinds, it being understood that both blinds and shades are intended unless otherwise stated.

The present invention cooperates with the existing window blind systems to provide a safe window blind system. Accordingly, a safety device for a window blind system is provided which consists of a telescoping pole which includes a predetermined number of tubular sections of similar lengths and a handle at one extremity. The tubular sections are slidingly engaged with each other which provide a variable length for the telescoping pole. The handle is hollow inside. In an embodiment of the present invention, handle is secured to tubular section by means of press fitting. At one end of the tubular section there provided a hole which facilitates installation of the telescoping pole to a window blind.

The particular length, size and the total quantity of each tubular section comprising each telescoping pole can vary depending upon the overall requirement for the telescoping pole. Limiters, which are annular rings, are press fitted at the extremities of the tubular sections of the telescoping pole which prevents the tubular sections from totally coming out from engagement with each other.

In an embodiment of the present invention, the safety device is attached to the head rail by means of a simple clip and wire mechanism which is passed through hole provided at the upper tubular section of the telescoping pole. The cord is passed through the passage provided inside the safety device from upper end of the first tubular section all the way to the handle. The end of the cord, after taking it out from the bottom of the handle, is tied into a knot so that the cord does not go back.

By pulling down or extending the telescoping pole, the blind can be lifted and, by pushing up or retracting the telescoping pole, the blind can be lowered. The cord remains inside the telescoping pole irrespective of the position of the blind without any loose hanging portion. Thus, the telescoping pole of the present invention, when installed to a conventional blind, does not leave any portion of the blind cord loose and, hence, completely eliminates risk of a child playing with a loose hanging blind cord and getting strangulated.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A is a broken front elevational view of the safety device of the present invention illustrated in the fully extended position;

FIG. 1B is a broken front elevational sectional view of the safety device of the present invention illustrated in the fully extended position;

FIG. 2 is a partial perspective sectional view of the ends of adjacent sections of the telescoping pole of the present invention with limiters positioned there between;

FIG. 3 is a perspective view of the safety device of the present invention illustrated in the fully extended position;

FIG. 4 shows a conventional horizontal blind in partially lifted condition;

FIG. 5 is a conventional horizontal blind in partially lifted condition with safety device of the present invention installed;

FIG. 6 is a conventional horizontal blind in lowered condition with safety device of the present invention installed;

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The invention is now described with reference to the drawings, wherein like reference numerals are used to refer to like elements throughout. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention. In the following description, for purpose of explanation, numerous specific details are set forth in order to provide a thorough understanding thereof. It may be evident, however, that the invention can be practiced without these specific details.

The safety device of the present invention has a mechanism that can be used in window blinds that will prevent cords from being pulled away from a fully lowered blind. This mechanism does not detract from either the operation or appearance of the blind. The mechanism of the present invention prevents anyone from grasping a cord of a fully lowered blind and from forming of a loop. Thus, children are protected from getting entangled in a cord loop created from a cord and are thus saved from getting strangled.

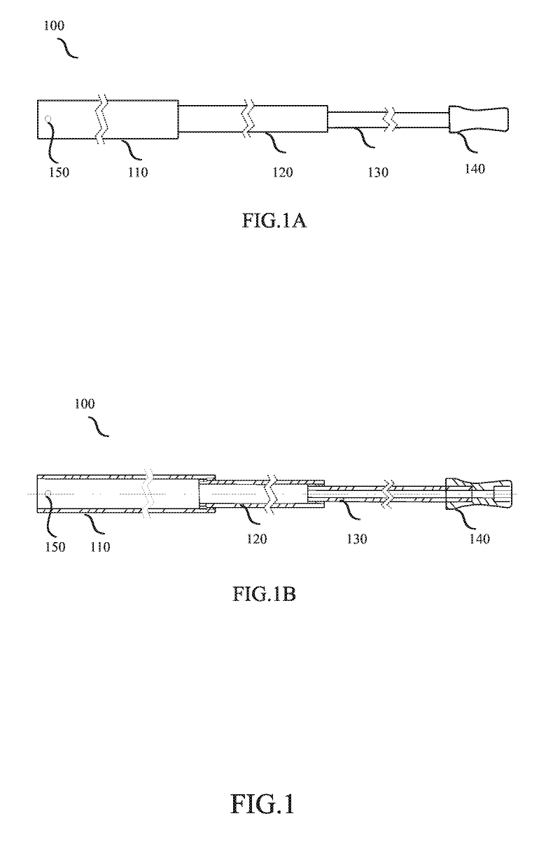

FIG. 1A illustrates a safety device 100 of the present invention which comprises a telescoping pole and a handle. The telescoping pole is attached to a handle 140 at one extremity. The telescoping pole includes a predetermined number of tubular sections such as first tubular section 110, second tubular section 120 and a third tubular section 130 of similar lengths and a handle 140 at one extremity. The tubular sections 110, 120 and 130 are slidingly engaged with each other which provide a variable length for the telescoping pole. The handle 140 is hollow inside. In an embodiment of the present invention, as can be seen in FIG. 1B, handle 140 is secured to tubular section 130 by means of press fitting. At one end of the first tubular section 110 there provided a hole 150 which facilitates installation of the safety device 100 to a window blind.

To facilitate telescoping engagement of the sections 110 to 130, the tubular sections 110 to 130 are provided with progressively decreasing cross-sectional dimensions as illustrated in FIG. 1A and FIG. 1B wherein the first tubular section 110 has the largest cross-sectional dimension and third tubular section 130 has the smallest cross-sectional dimension. The sections 110 to 130 are tubular and have a close-fit slidingly engaged relation one with the other. This close fit engagement ensures that, when extended, the telescoping pole would have little or no transverse movement and would remain co-axial.

FIG. 1B illustrates a sectional view of the safety device 100 of the present invention which reveals that the tubular sections 110 to 130 along with the hollow handle 140 provides a thorough passage from one extremity to the other in extended condition. This thorough passage would remain same even when the telescoping pole is in retracted condition.

The particular length, size and the total quantity of each tubular section 110 to 130 comprising the telescoping pole can vary depending upon the overall requirement for the safety device 100. It would be obvious to any person skilled in the art that any combination of lengths, sizes and quantity of tubular sections may be used to provide the desired length, size and satisfy the intended uses of the safety device 100.

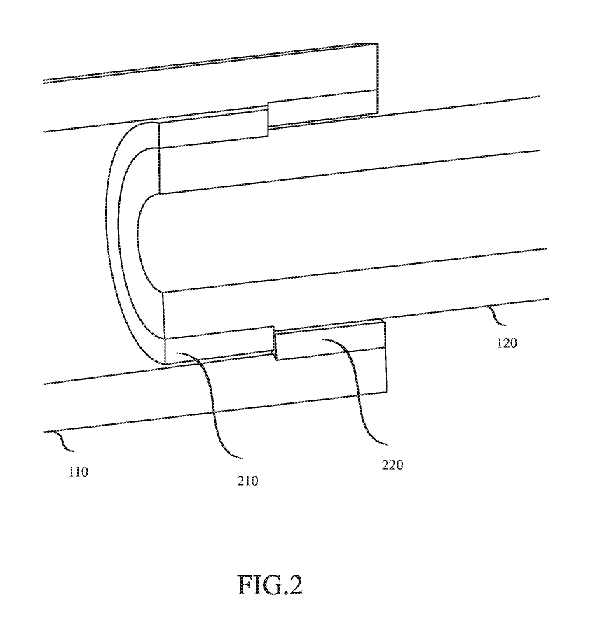

FIG. 2 illustrates an exemplary embodiment of the present invention wherein, at one extremity, at the inner periphery of the first tubular section 110, a limiter 220 is press fitted. Similarly, a limiter 210 is press fitted at the outer periphery of the second tubular section 120 at one end after inserting the second tubular section 120 through the first tubular section 110. The limiters 210 and 220 ensures that the first tubular section 110 and the second tubular section 120 do not come out of engagement completely while being extended. The limiters 210 and 220 also guide axial movement of the tubular sections 110 and 120. The same kind of limiter arrangement is also made between tubular sections 120 and 130.

The particular length, size, total quantity and means of fitting the limiters can vary depending upon the overall requirement for the safety device 100. It would be obvious to any person skilled in the art that any combination of lengths, sizes and quantity of limiters may be used to provide the desired length, size and satisfy the intended uses of the safety device 100.

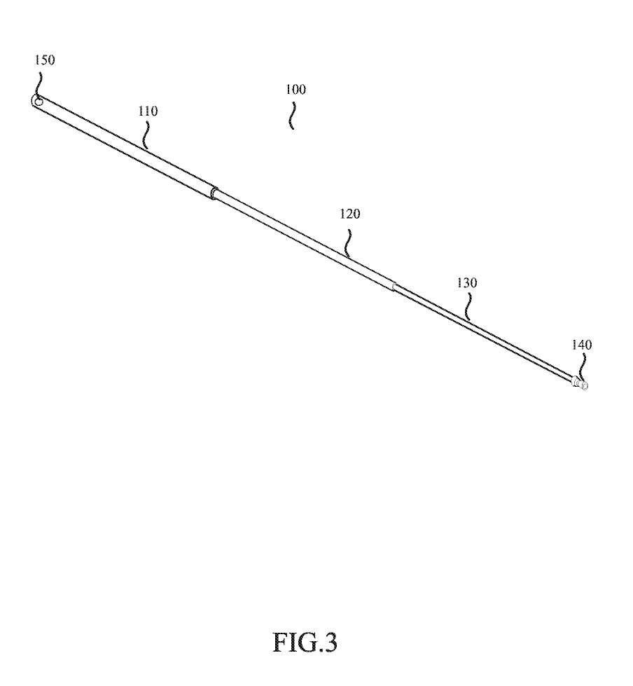

FIG. 3 illustrates a perspective view of the safety device 100 in extended condition.

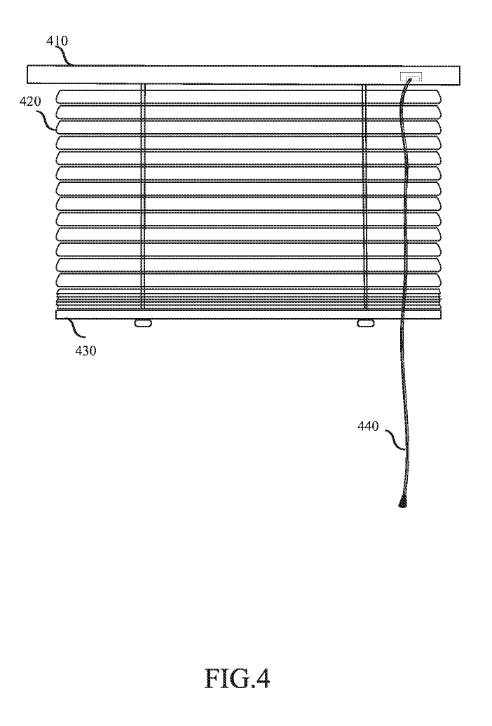

FIG. 4 illustrates a conventional blind in partially lifted condition which comprises of a head rail 410, a bottom rail 430 and a plurality of slates 420 horizontally arranged between the head rail 410 and bottom rail 430. A cord 440 is also shown in FIG. 4 by means of which the blind can be operated. As can be seen in FIG. 4, when the blind is in lifted condition, be it partially or fully, the cord 440 hangs loosely from head rail 410. If a child play with this cord and wraps it around him, it may lead to strangulation of the child.

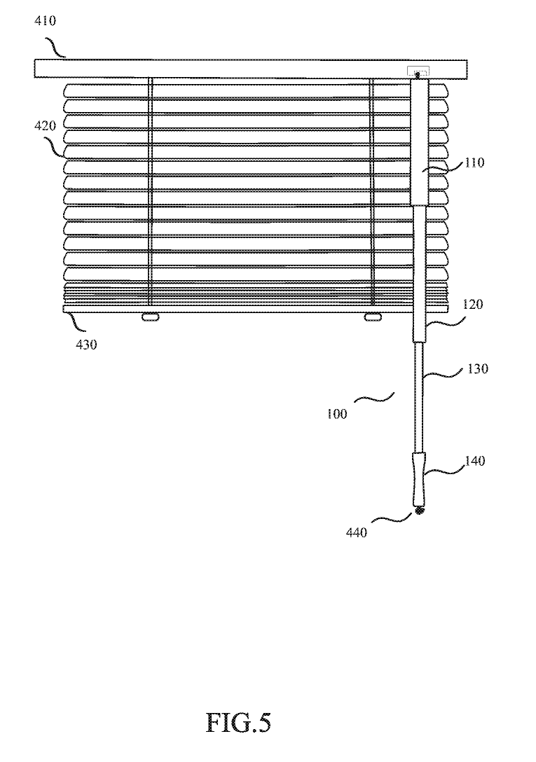

Referring to FIG. 5, in an embodiment of the present invention, the same conventional blind of FIG. 4 in partially lifted condition is shown with the safety device 100 extended and attached to the head rail 410. The safety device 100 is attached to the head rail 410 by means of a simple clip and wire mechanism (not shown in figures) which is passed through hole 150 shown in FIG. 1A, FIG. 1B and in FIG. 3. The cord 440 is passed through the passage provided inside the safety device 100 from upper end of the first tubular section 110 all the way to the handle 140. The end of the cord 440, after taking it out from the bottom of the handle 140, is tied into a knot so that the cord 440 does not go back.

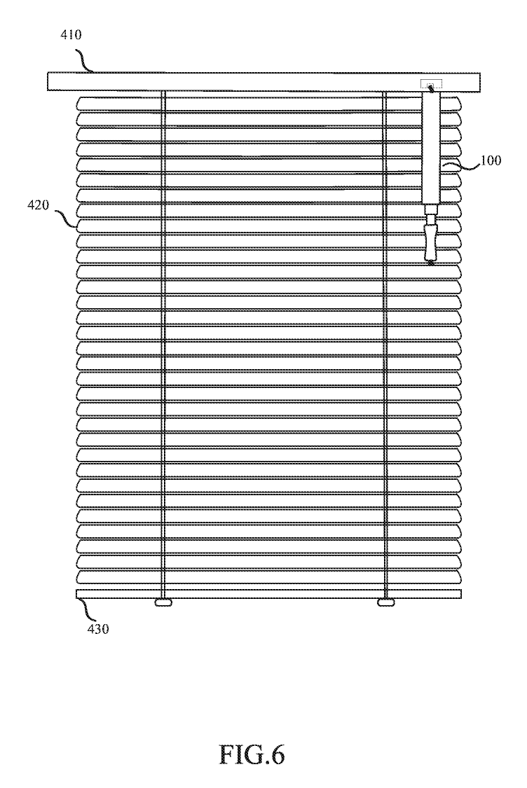

FIG. 6 illustrates a conventional blind in fully lowered condition with the safety device 100 of the present invention installed to head rail 410. As can be seen in FIG. 6, to lower the blind, a person can push the safety device 100 upward and, as the tubular sections of the telescoping pole retract, the cord 440 goes up and the blind gets lowered.

Referring to FIG. 4, FIG. 5 and FIG. 6 together, it can be seen that, by pulling down or extending the telescoping pole of the safety device 100, the blind can be lifted and, by pushing up or retracting the telescoping pole of the safety device 100, the blind can be lowered. The cord 440 remains inside the safety device 100 irrespective of the position of the blind without any loose hanging portion. Thus, the safety device 100 of the present invention, when installed to a conventional blind, does not leave any portion of the blind cord loose and, hence, completely eliminates risk of a child playing with a loose hanging blind cord and getting strangulated.

Telescoping pole of the safety device 100 can be manufactured from any suitable material known in the art such as polyetheretherketone (PEEK) etc. Telescoping pole of the safety device 100 can also be manufactured in a variety of sizes and colors to accommodate user preference.

Handle 140 can be manufactured from any suitable material known in the art such as PE High Density Film etc. Handle 140 can also be manufactured in a variety of sizes, designs and colors to accommodate user preference.

Additionally, other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A safety device for a window blind, comprising of:
a telescoping pole having plurality of tubular sections; and
a handle;
wherein a first tubular section of said telescoping pole is attached to a window blind and a third tubular section of said telescoping pole is attached to said handle and at least one cord from said window blind is fed through said plurality of tubular sections all the way to said handle wherein said cord is tied into a knot so said cord doesn't go back through said handle whereby said safety device protects kids from wrapping themselves up in said cord.

2. The safety device for a window blind as in claim 1, wherein a plurality of limiters are connected to said plurality of tubular sections of said telescoping pole.

3. The safety device for a window blind as in claim 1, wherein said handle is manufactured from PE High Density Film and any other suitable material.

4. The safety device for a window blind as in claim 1, wherein said handle is manufactured in a variety of sizes, designs and colors.

5. The safety device for a window blind as in claim 1, wherein said telescoping pole is manufactured from polyetheretherketone (PEEK) and any other suitable material.

6. The safety device for a window blind as in claim 1, wherein said telescoping pole is manufactured in a variety of sizes and colors.

7. The safety device for a window blind as in claim 1, wherein said handle is hollow.

8. The safety device for a window blind as in claim 1, wherein said cord remains fully inside said safety device when said safety device is in extended condition.

9. The safety device for a window blind as in claim 1, wherein said cord remains fully inside said safety device when said safety device is in retracted condition.

10. The safety device for a window blind as in claim 1, wherein said cord remains fully inside said safety device in any condition of said safety device.
